(19) United States
(12) Patent Application Publication
(10) Pub. No.: US 2014/0340303 A1
(43) Pub. Date: Nov. 20, 2014

(54) DEVICE AND METHOD FOR DETERMINING GESTURE

(71) Applicant: Samsung Electronics Co., Ltd., Gyeonggi-do (KR)

(72) Inventor: Grzegorz Pawel GRZESIAK, Warsaw (PL)

(73) Assignee: Samsung Electronics Co., Ltd., Gyeonggi-do (KR)

(21) Appl. No.: 14/278,108

(22) Filed: May 15, 2014

(30) Foreign Application Priority Data
May 16, 2013 (KR) 10-2013-0055528

(51) Int. Cl. G06F 3/01

(52) U.S. Cl. CPC G06F 3/017
USPC 345/156

(57) ABSTRACT

A device and method are provided for determining a gesture. When a single form is generated through a gesture, a type of gesture generating the single form is detected. A function corresponding to the detected type of gesture is performed.

### PRIORITY

This application claims priority under 35 U.S.C. §119(a) to Korean Application Serial No. 10-2013-0055528, which was filed in the Korean Intellectual Property Office on May 16, 2013, the entire content of which is incorporated herein by reference.

### BACKGROUND OF THE INVENTION

1. Field of the Invention

The present invention relates generally to a device and a method for determining a gesture, and more particularly, to a device and a method for determining a type of gesture capable from various types of gestures having a single form.

2. Description of the Related Art

Devices, including an input device, may be controlled by various methods. For example, a gesture may be generated on a screen by using a pointing device, a hand, or a finger. The generated gesture may be interpreted to perform an operation, such as, for example, “page movement” or “application termination”. In the performance of a corresponding function through a gesture, a user may define a gesture to perform a specific function, or replace the specific function with another function for the gesture.

### SUMMARY OF THE INVENTION

The present invention has been made to address at least the above problems and/or disadvantages and to provide at least the advantages described below. Accordingly, an aspect of the present invention provides a device and a method for determining a type of gesture from various types of gestures in a single form.

In accordance with an aspect of the present invention, a device is provided for determining a gesture. The device includes a memory that stores types of gestures that generate a single form, and stores specific functions corresponding to the types of gestures. The device also includes controller that detects a type of gesture generating the single form when the single form is generated, and performs a specific function corresponding to the detected type of gesture.

In accordance with an aspect of the present invention, a method is provided for determining a gesture. When a single form is generated through a gesture, a type of gesture generating the single form is detected. A specific function corresponding to the detected type of gesture is performed.

### BRIEF DESCRIPTION OF THE DRAWINGS

The above and other aspects, features, and advantages of the present invention will be more apparent from the following detailed description when taken in conjunction with the accompanying drawings, in which:

FIG. 1 is a diagram illustrating a terminal, according to an embodiment of the present invention;

FIGS. 2A to 2C are drawings illustrating various gestures in a single form according to a start position, according to embodiments of the present invention;

FIGS. 3A to 3C are drawings illustrating the types of gestures generating a single form, according to embodiments of the present invention;

FIG. 4 is a flowchart illustrating a process of performing a specific function according to a type of gesture generating a single form in the terminal, according to an embodiment of the present invention;

FIG. 5 is a flowchart illustrating a process of performing a specific function according to a type of gesture generating a single form in the terminal, according to another embodiment of the present invention; and

FIG. 6 is a flowchart illustrating a process of performing a specific function according to a type of gesture generating a single form in the terminal, according to an additional embodiment of the present invention.

### DETAILED DESCRIPTION OF EMBODIMENTS OF THE PRESENT INVENTION

Embodiments of the present invention are described in detail with reference to the accompanying drawings. The same or similar components are designated by the same or similar reference numerals although they are shown in different drawings. Detailed descriptions of constructions or processes known in the art may be omitted to avoid obscuring the subject matter of the present invention.

A terminal according to various embodiments of the present invention may be embodied as a portable terminal or a fixed terminal. The portable terminal is a portable and mobile electronic device, and may include a video phone, a portable phone, a smart phone, a Wideband Code Division Multiple Access (WCDMA) terminal, a Universal Mobile

Telecommunication Service (UMTS) terminal, Personal Digital Assistants (PDAs), a Portable Multimedia Player (PMP), a Digital Multimedia Broadcasting (DMB) terminal, an E-book reader, a portable computer (a notebook computer and a tablet computer), or a digital camera. Further, the fixed terminal may include a desktop personal computer and the like.

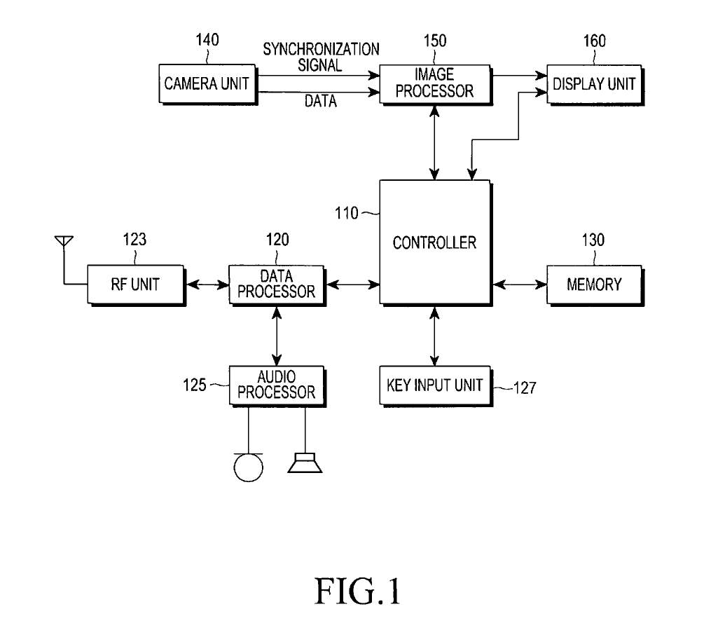

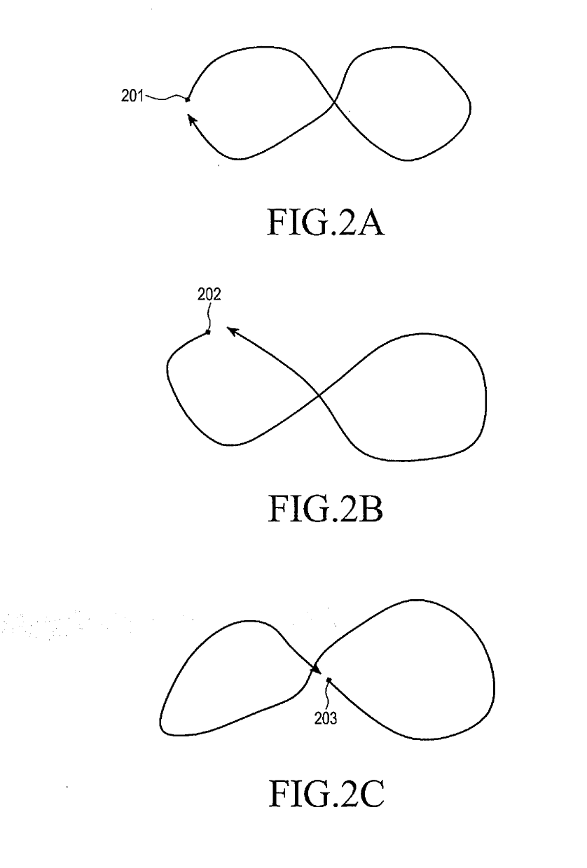

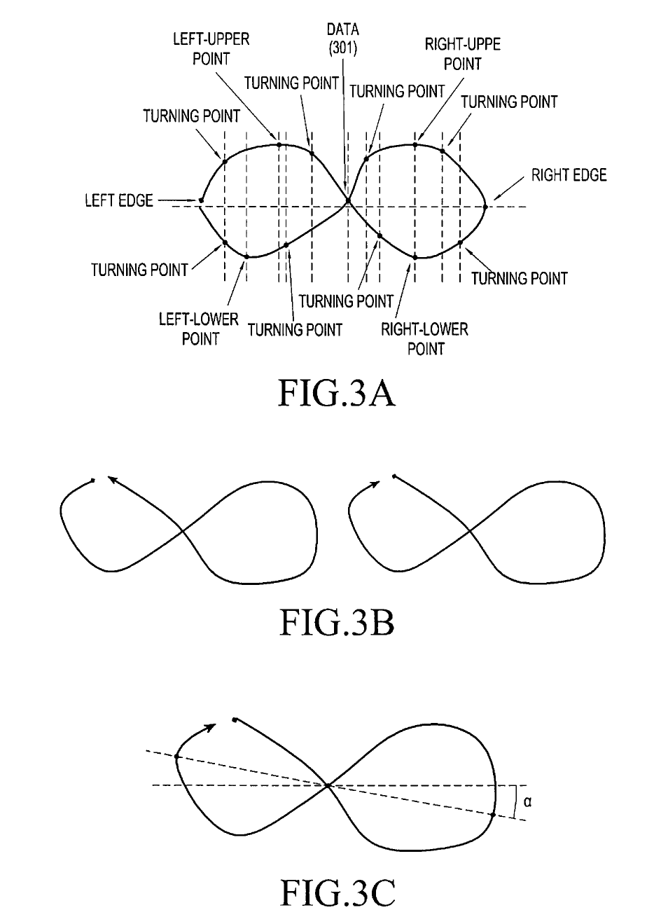

FIG. 1 is a diagram of a terminal according to embodiments of the present invention. FIGS. 2A to 2C are drawings illustrating various gestures in a single form according to the start position, according to embodiments of the present invention. FIGS. 3A to 3C are drawings illustrating the types of gestures generating a single form, according to embodiments of the present invention.

Referring to FIG. 1, an RF unit 123 performs a wireless communication function of a portable terminal. The RF unit 123 includes an RF transmitter for up-converting and amplifying a frequency of a transmitted signal, and an RF receiver for low-noise amplifying a received signal and down-converting a frequency. A data processor 120 may include a transmitter for encoding and modulating the transmitted signal, and a receiver for demodulating and decoding the received signal. The data processor 120 may be formed of a modem and a codec. The codec may include a data codec for processing packet data, etc., and an audio codec for processing an audio signal, such as a voice. An audio processor 125 may perform a function of reproducing a received audio signal output from the audio codec of the data processor 120, or transmitting a transmitted audio signal generated in a microphone to the audio codec of the data processor 120.

A key input unit 127 may include keys for inputting number and character information, and functional keys for setting various functions.

A memory 130 may be formed of a program memory and a data memory. The program memory may store programs that control a general operation of the terminal, and programs controlling performance of a specific function corresponding to the type of gesture generating a single form. Further, the data memory may perform a function of temporarily storing data generated during the performance of the programs.

Further, the memory 130 may store the type of gesture generating a single form and a specific function corresponding to the type of the gesture according to embodiments of the present invention.

The type of gesture will be described in detail below with reference to FIGS. 2 to 3.

A controller 110 performs the general operations of the portable terminal.

When a single form is generated, according to embodiments of the present invention, the controller 110 may detect a type of gesture generating the single form, and perform a specific function corresponding to the type of detected gesture.

The type of gesture, according to embodiments of the present invention, may include at least one of a start position of a gesture generating the single form, a direction of a gesture generating the single form, an inclination of the single form.

The single form, according to embodiments of the present invention, may be an infinity symbol having a curved shape, a start position, and an end position. Accordingly, when the single form is an infinity symbol, a plurality of generated gesture motions are described in FIGS. 2 and 3.

When the infinity symbol is generated by a hand of a user or a touch pen in FIG. 2A, a start position 201 is generated at a left side of a curved line. When the infinity symbol is generated in FIG. 2B, a start position 202 is located in a left-upper portion of a curved line. When the infinity symbol is generated in FIG. 2C, a start position 203 is located in the center of a curved line.

In FIGS. 2A to 2C, which have the different start positions, respectively, three different gesture motions may be generated. The start position is not limited to FIGS. 2A to 2C.

15 feature points may be detected in an infinity symbol, as illustrated in FIG. 3A. The respective 15 feature points may serve as different start positions, so that a plurality of gesture motions may be accordingly generated.

Further, a plurality of gestures may be generated even in different directions generating the infinity symbol, as illustrated in FIG. 3B Four directions may be detected at a center 301, as illustrated in FIG. 3A.

Further, in FIG. 3C, based on an example of an inclination of the infinity symbol, a plurality of gesture motions may be generated according to 0°, 45°, 92°, 135°, and the like.

Through a combination of FIGS. 3A to 3C, a plurality of gestures may be generated only through the generation of the infinity symbol in the single form.

When the plurality of gestures generated through the combination of FIGS. 3A to 3C and specific functions corresponding to the respective gestures are stored in the memory 130, and when the infinity symbol is generated in the single form, the controller 110 may detect a start position of a gesture generating the infinity symbol, detection of a specific function corresponding to a type of gesture having the start position of the detected gesture in the memory 130 when the start position of the gesture is detected, and perform the detected specific function.

Further, when the infinity symbol is generated in the single form, the controller 110 may detect a start position of a gesture generating the infinity symbol, and detect a direction of the gesture generating the infinity symbol when the start position of the gesture is detected. When the direction of the gesture is detected, the controller 110 may detect a specific function corresponding to a type of gesture having the detected start position of the gesture and the detected direction of the gesture, and perform the detected specific function.

Further, when the infinity symbol is generated in the single form, the controller 110 may detect a start position of a gesture generating the infinity symbol, and detect a direction of the gesture generating the infinity symbol when the start position of the gesture is detected. When the direction of the gesture is detected, the controller 110 may detect an inclination of the infinity symbol. When the inclination of the infinity symbol is detected, the controller 110 may detect a specific function corresponding to a type of gesture having the detected start position of the gesture, the detected direction of the gesture, and the detected inclination of the single form, and perform the detected specific function.

A camera unit 140 photographs image data, and includes a camera sensor for converting a photographed optical signal to an electric signal, and a signal processor for converting an analog image signal photographed by the camera sensor to digital data. It is assumed that the camera sensor is a CCD sensor or a CMOS sensor, and the signal processor may be implemented as a Digital Signal Processor (DSP). Further, the camera sensor may be integrally or separately formed with the signal processor.

An image processor 150 performs Image Signal Processing (ISP) for displaying an image signal output from the camera unit 140 on the display unit 160. The ISP performs a function, such as gamma correction, interpolation, a spatial change, an image effect, an image scale, Auto White Balance (AWB), Auto Exposure (AE), and Auto Focus (AF). Therefore, the image processor 150 processes an image signal output from the camera unit 140 frame by frame, and outputs the frame image data in accordance with a characteristic and a size of the display unit 160. Further, the image processor 150 includes an image codec, and compresses frame image data displayed on the display unit 160 by a preset scheme, or restores the compressed frame image data to original frame image data. The image codec may include a JPEG codec, an MPEG4 codec, a Wavelet codec, etc. It is assumed that the image processor 150 has an On Screen Display (OSD) function and may output OSD data in accordance with a screen size displayed under the control of the controller 110.

The display unit 160 displays an image signal output from the image processor 150 on a screen and displays user data output from the controller 110. The display unit 160 may use an LCD, and in this case, the display unit 160 may include an LCD controller, a memory capable of storing image data, and an LCD display device. When the LCD is implemented by a touch screen scheme, the LCD may serve as an input unit, and in this case, the display unit 160 may display keys, such as the key input unit 127.

Further, when the display unit 160 is used as a touch screen unit according to the implementation of the display unit 160 by the touch screen scheme, the touch screen unit is formed of a Touch Screen Panel (TSP) including a plurality of sensor panels. The plurality of sensor panels may include an electrostatic sensor panel capable of recognizing a touch of a hand, and an electromagnetic inducing sensor panel capable of sensing a touch, such as a touch pen.

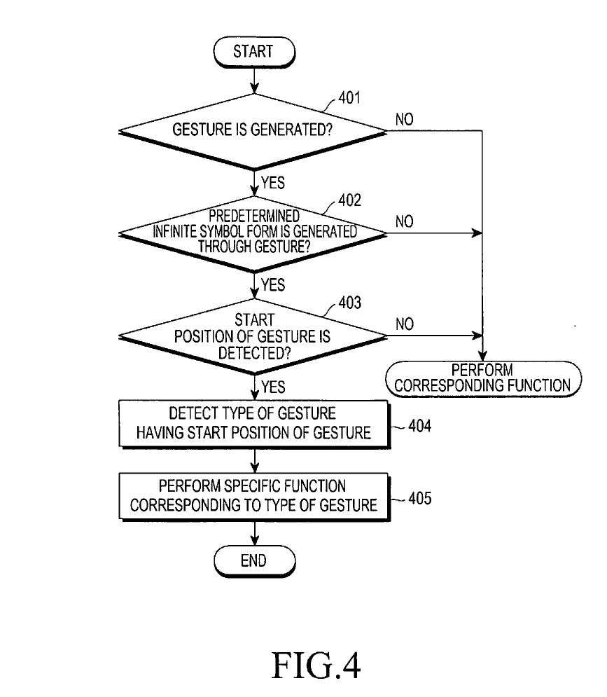

An operation of determining a gesture in the terminal is described in greater detail below with reference to FIGS. 4 to 6. In embodiments of the present invention, the infinity symbol has been described as an example of the single form, but all of the forms shaped like a curved line having a start position and an end position, as well as the infinity symbol, may be included. Further, in embodiments of the present invention, a case where the type of gesture includes at least one of the start position of the gesture generating the single form, the direction of the gesture generating the single form, and the inclination of the single form has been described as an example, but the type of the gesture is not limited to the aforementioned types, and may include all of the characteristics distinguishable from each other in the infinity symbol for use.

FIG. 4 is a flowchart illustrating a process of performing a specific function according to a type of gesture generating a single form in the terminal, according to an embodiment of the present invention.

The embodiment of the present invention is described with reference to FIG. 4 together with FIG. 1.

Referring to FIG. 4, the controller 110 determines whether a gesture is generated, in operation 401. When it is determined that the gesture is generated, the controller 110 determines whether an infinity symbol form is generated as a single form through the gesture, in operation 402. When it is determined that the infinity symbol form is generated through the gesture, the controller 110 determines whether a start position of the gesture generating the infinity symbol form is detected, in operation 403.

When the start position of the gesture generating the infinity symbol form is detected, a type of gesture having the detected start position of the gesture is detected in the memory 130, in operation 404. the controller 110 performs a specific function corresponding to the type of gesture detected in the memory 130, in operation 405.

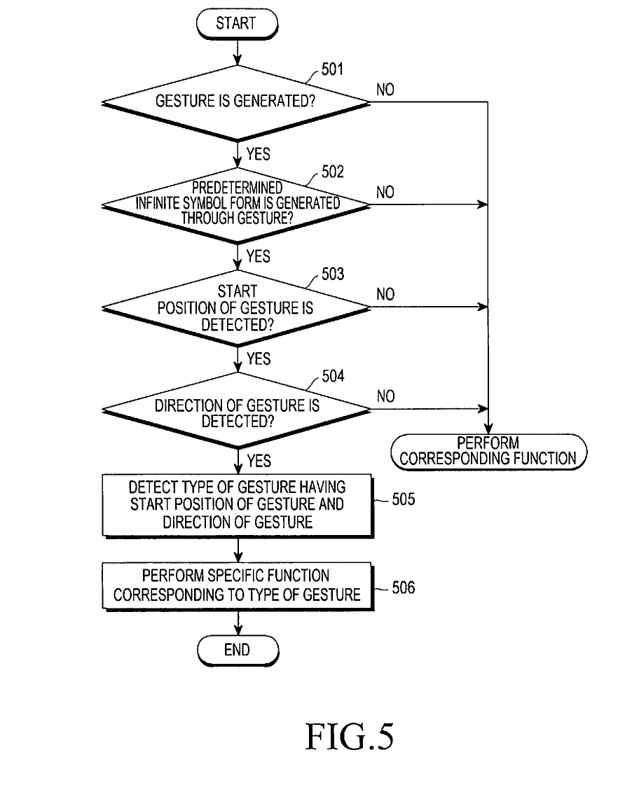

FIG. 5 is a flowchart illustrating a process of performing a specific function according to a type of gesture generating a single form in the terminal, according to an embodiment of the present invention.

The embodiment of the present invention is described with reference to FIG. 5 together with FIG. 1.

Referring to FIG. 5, the controller 110 determines whether a gesture is generated, in operation 501. When it is determined that the gesture is generated, the controller 110 determines whether an infinity symbol form is generated as a single form through the gesture, in operation 502. When it is determined that the infinity symbol form is generated through the gesture, the controller 110 determines whether a start position of the gesture generating the infinity symbol form is detected, in operation 503.

When the start position of the gesture generating the infinity symbol form is detected in operation 503, the controller 110 determines whether a moving direction of the gesture generating the infinity symbol form is detected, in operation 504.

When the moving direction of the gesture generating the infinity symbol form is detected in operation 504, a type of gesture having the detected position of the gesture and the detected moving direction of the gesture is detected in the memory 130, in operation 505. The controller 110 performs a specific function corresponding to the type of gesture detected in the memory 130, in operation 506.

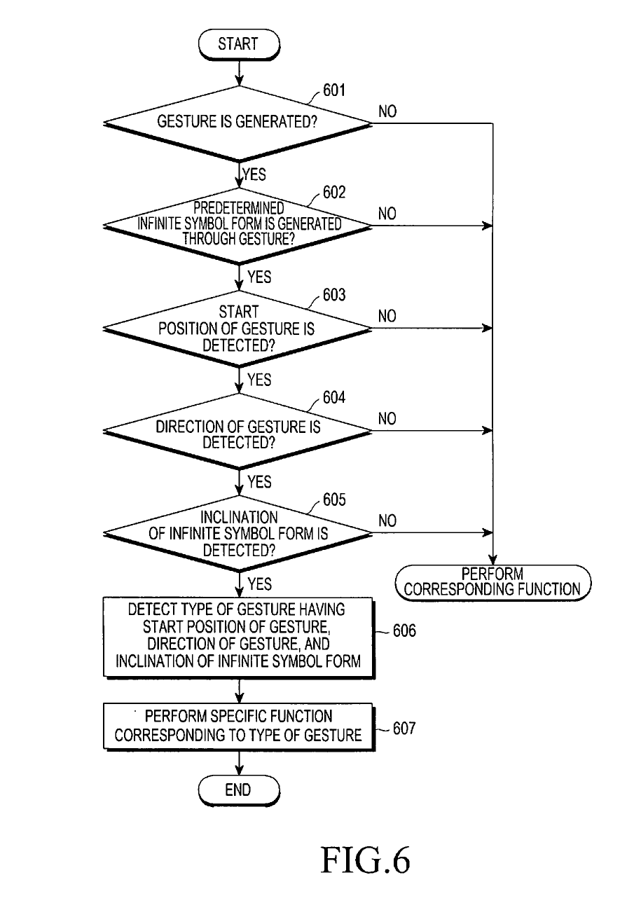

FIG. 6 is a flowchart illustrating a process of performing a specific function according to a type of gesture generating a single form in the terminal, according to an embodiment of the present invention.

The embodiment of the present invention is described with reference to FIG. 6 together with FIG. 1.

Referring to FIG. 6, the controller 110 determines whether a gesture is generated, in operation 601. When it is determined that the gesture is generated, the controller 110 determines whether an infinity symbol form is generated as a single form through the gesture, in operation 602. When it is determined that the infinite symbol form is generated through the gesture, the controller 110 determines whether a start position of the gesture generating the infinite symbol form is detected, in operation 603.

When the start position of the gesture generating the infinite symbol form is detected, the controller 110 determines whether a moving direction of the gesture generating the infinite symbol form is detected, in operation 604.

When the start position of the gesture generating the infinite symbol form is detected, the controller 110 determines whether an inclination of the infinite symbol form is detected, in operation 605.

When the inclination of the infinity symbol form is detected, a type of gesture having the detected position of the gesture, the detected moving direction of the gesture, and the detected inclination of the infinite symbol is detected in the memory 130, in operation 606. The controller 110 performs a specific function corresponding to the type of gesture detected in the memory 130, in operation 607.

The device and the method for determining the gesture of the present invention may be implemented by computer readable code in a computer readable recording medium. The computer readable recording medium includes every type of recording device in which data readable by a computer system is stored. Examples of the computer readable recording medium include ROM, RAM, optical disks, magnetic tapes, floppy disks, hard disks, and non-volatile memory, and storage media such as carrier waves (e.g., transmission through the Internet). Further, the computer readable recording medium is distributed to computer systems connected through a network, so that a computer readable code may be stored and executed by a distribution method.

While the present invention has been shown and described with reference to certain embodiments thereof, it will be understood by those skilled in the art that various changes in form and detail may be made therein without departing from the spirit and scope of the present invention as defined by the appended claims.

What is claimed is:

1. A device for determining a gesture, comprising:
a memory that stores types of gestures that generate a single form, and stores specific functions corresponding to the types of gestures; and
a controller that detects a type of gesture generating the single form when the single form is generated, and performs a specific function corresponding to the detected type of gesture.

2. The device of claim 1, wherein the single form comprises an infinity symbol having a form of a curved line with a start position and an end position.

3. The device of claim 1, wherein the types of gestures comprise at least one of a start position of the gesture generating the single form, a direction of the gesture generating the single form, and an inclination of the single form.

4. The device of claim 1, wherein, when the single form is generated, the controller detects a start position of the gesture generating the single form, and detects the specific function corresponding to the type of gesture having the detected start position of the gesture in the memory.

5. The device of claim 1, wherein, when the single form is generated, the controller detects a start position of the gesture generating the single form, detects a direction of the gesture generating the single form, and detects the specific function corresponding to the type of gesture having the detected start position of the gesture and the detected direction of the gesture in the memory.

6. The device of claim 1, wherein, when the single form is generated, the controller detects a start position for generating the single form, detects a direction of the gesture generating the single form, detects an inclination of the single form, and detects the specific function corresponding to the type of gesture having the detected start position of the gesture, the detected direction of the gesture, and the detected inclination of the single form in the memory.

7. A method of determining a gesture, comprising :
when a single form is generated through a gesture, detecting a type of gesture generating the single form; and
performing a specific function corresponding to the detected type of gesture.

8. The method of claim 7, wherein the single form comprises an infinity symbol having a form of a curved line with a start position and an end position.

9. The method of claim 7, wherein types of gestures comprise at least one of a start position of the gesture generating the single form, a direction of the gesture generating the single form, and an inclination of the single form.

10. The method of claim 7, wherein detecting the type of gesture comprises:
detecting a start position of the gesture generating the single form; and
detecting the type of gesture having the detected start position of the gesture.

11. The method of claim 7, wherein detecting the type of gesture comprises:
detecting a start position of the gesture generating the single form;
detecting a direction of the gesture generating the single form; and
detecting the type of gesture having the detected start position of the gesture and the detected direction of the gesture.

12. The method of claim 7, wherein detecting the type of gesture comprises:
detecting a start position of the gesture generating the single form;
detecting a direction of the gesture generating the single form;
detecting an inclination of the single form, and
detecting the type of gesture having the detected start position, the detected direction of the gesture, and the detected inclination of the single form.
